(19) United States
(12) Patent Application Publication
(10) Pub. No.: US 2020/0266640 A1
(43) Pub. Date: Aug. 20, 2020

(54) MULTI FUNCTION CHARGER CASE

(71) Applicant: Acouva, Inc., San Francisco, CA (US)

(72) Inventor: Victor Manuel Valenzuela, Hayward, CA (US)

(21) Appl. No.: 16/280,895

(22) Filed: Feb. 20, 2019

(51) Int. Cl. H02J 7/00; H04R 1/02

(52) U.S. Cl. CPC H02J 7/0044; H04W 84/12; H04R 1/028; H02J 7/0047

(57) ABSTRACT

Embodiments can include a multi function charger case (e.g., for use with one or more wireless in-ear utility devices, etc.) that can provide continuous charging capability with a convenient form factor, where the multi function charger case can include a first set of charging compartments for charging a set of utility devices insertable into the first set of charging compartments of the multi function charger case; and a second set of charging compartments for charging a set of battery modules insertable into the second set of charging components of the multi function charger case, wherein the set of battery modules is operable to power the set of utility devices upon charging of the set of battery modules by the multi function charger case; and/or where the multi function charger case can additionally or alternatively function as an assistant listening device.

### TECHNICAL FIELD

The disclosure generally relates to one or more charger devices.

### BACKGROUND

The following background description includes information that may be useful in understanding context in relation to embodiments described herein. The background description is not an admission that any of the information provided herein is prior art or relevant to the embodiments, or that any publication specifically or implicitly referenced is prior art.

With the development of portable multimedia devices and smart phones, many types of in-ear pieces—such as earphones and headsets—have been developed, and associated chargers can use unconventional methods of charging, can be too large and bulky, and/or can require multiple hours or days to charge the corresponding devices. Additionally, conventional charger cases can be bulky and/or uncomfortable for placement into a pocket and/or other compartments. Additionally, charge cases can be limited in their technological abilities and/or limited by their technological requirements (e.g., thereby limiting exploration of new form factors).

Therefore, a need exists for an improved and advanced charger case(s) that can efficiently charge devices while facilitating user comfort for long periods of time and under a variety of conditions.

### BRIEF DESCRIPTION OF THE FIGURES

Figures provided herein may or may not be provided to scale. The relative dimensions or proportions may vary.

FIG. 1 includes an illustration of a multi function charger case (e.g., miniature; etc.) 101 including a micro USB-C fast charging port 102, and three to five light-emitting diodes (LEDs) 103, 104, 105 to provide the user feedback (e.g., visual feedback; in relation to providing feedback regarding one or more chargeable device modules, such as one or more wireless in-ear utility device; etc.), where in a specific example, the LEDs can flash three colors red for 0% to 20% charged, blue for 20% to 50% charged, and green for 50% to 100% charged, and when it's 100% charged the LEDs turn-off, according to a variation of an embodiment. FIG. 1 additionally includes an illustration of battery modules 106, 107, which can additionally or alternatively facilitate provision of user feedback (e.g., visual feedback; etc.) such as in the form of LEDs, where such user feedback can be the same or different from feedback associated with LEDs 103, 104, 105, according to a variation of an embodiment.

FIG. 2 includes an illustration of multi function charger case (e.g., miniature; etc.) with an outer circumference designed to accommodate a shape that can be conveniently put in a pocket and/or purse so that the user can carry the miniaturize multi charger around (e.g., all day and/or for any suitable period of time; etc.), such as based on the dimensions indicated by 201, 202 and/or 203 for the form factor. In a specific example, as shown in FIG. 2, where if the battery modules are not included, removed, or not needed as part of the multi function charger case (e.g., miniature; etc.) configuration, the additional LEDs (e.g., 106, 107 as shown in FIG. 1) are not visible at the location shown by 204 (e.g., where LEDs 106 and/or 107 can be located at such locations as shown in FIG. 1 when one or more battery modules are included; etc.), according to a variation of an embodiment.

FIG. 3 includes an illustration of a multi function charger case (e.g., miniature; etc.) 301; two battery modules 303, 305 inserted into the multi function charger case (e.g., miniature; etc.) 301; a lid 304 (e.g., physically attached to the multi function charger case 301, etc.) include a magnetic latch (e.g., and/or other suitable latch type) to hold the battery modules from falling out of the charger case, such as where the multi function charger case (e.g., miniature; etc.) 301 can charge two battery modules simultaneously or one at a time (e.g., in serial, individually etc.), according to a variation of an embodiment.

FIG. 4 includes an illustration of a multi function charger case (e.g., miniature; etc.) 401; two wireless in-ear utility device modules 402, 404 (and/or other suitable devices) inserted into multi function charger case (e.g., miniature; etc.) 401; a lid 403 including a magnetic latch (e.g., and/or other suitable latch type) to hold the wireless in-ear utility device modules 402, 404 from falling out of the multi function charger case (e.g., miniature; etc.) 401, such as where the magnet is located for and used to turn off and/or disconnect one or more wireless in-ear utility device modules 402, 404 while charging in the multi function charger case (e.g., miniature; etc.) 401, according to a variation of an embodiment.

FIG. 5 includes an illustration of a multi function charger case (e.g., miniature; etc.) 501; two battery modules 503, 504 entering the compartments (e.g., cavities; etc.) 502, 505, respectively, of the multi function charger case (e.g., miniature; etc.) 501; and one or more utility device battery modules 506 of one or more wireless in-ear utility devices and/or other suitable utility devices, such as where the utility device battery module 506 can snap out of one or more wireless in-ear utility devices (e.g., to be operated based on the one or more battery modules; etc.); such as where the one or more utility device battery modules 506 can be chargeable by the charger cases simultaneously or individually along with the battery modules 503, 504 when the one or more utility device battery modules 506 and the battery modules 503, 504 are inserted in the multi function charger case 501; such as where the utility device battery module can be replaced by a fully (or partially) charged battery module 503 or fully (or partially) charged battery module 504, according to a variation of an embodiment.

FIG. 6 includes an illustration of a multi function charger case (e.g., miniature; etc.) 601; two wireless in-ear utility device modules 603, 604 (e.g., connected to utility device battery modules; etc.) entering the compartments (e.g., cavities; etc.) 602, 605 of the multi function charger case (e.g., miniature; etc.) 601, according to a variation of an embodiment.

FIG. 7 includes an illustration of a multi function charger case (e.g., miniature; etc.) 701 and a USB-C port 702 for fast charging, which can allow a user to have two (and/or any suitable number) wireless in-ear utility device modules (e.g., including two utility device battery modules) and two (and/or any suitable number) battery modules (e.g., individual battery modules, etc.) to be charged (e.g., fully charged in 30 minutes or less; in any suitable time period; etc.), such as where the internal battery of the charger case can have any suitable battery life (e.g., up to 40 hours of battery life, etc.) and can allow for the user to charge wireless in-ear utility device modules and/or individual battery modules any suitable number of times (e.g., 5 times, etc.) before having to recharge the multi function charger case (e.g., miniature; etc.), according to a variation of an embodiment.

### DESCRIPTION OF EMBODIMENTS

The following description of the embodiments is not intended to limit the invention to these embodiments, but rather to enable any person skilled in the art to make and use.

Embodiments can include one or more multi function charger cases (e.g., one or more miniature multi function charger cases; etc.), which can function to charge one or more (e.g., 2, etc.) in-ear utility device modules and/or one or more (e.g., 2, etc.) battery modules (e.g., individual battery modules), such as where the multi function charger case can charge the one or more in-ear utility device modules and the one or more battery modules simultaneously (e.g., simultaneously charging 2 in-ear utility device modules and 2 battery modules; etc.).

In a specific example, a multi function charger case can include a first set of charging compartments for charging a set of utility devices insertable into the first set of charging compartments of the multi function charger case; and a second set of charging compartments for charging a set of battery modules insertable into the second set of charging components of the multi function charger case, wherein the set of battery modules is operable to power the set of utility devices upon charging of the set of battery modules by the multi function charger case.

In embodiments, the multi function charger case (e.g., miniature; etc.), can be designed for user convenience of being able to carry in their pocket and/or in a purse and/or the suitable compartments. The multi function charger case (e.g., miniature; etc.) can be designed to supply charging power for up to 40 hours (and/or other suitable time periods). The multi function charger case (e.g., miniature; etc.) architecture can be designed for rapid charging (e.g., full charging in 30 minutes and/or other suitable time period; etc.), such as to charge two in-ear utility devices and two battery modules at the same time or separately and ready for use in 30 minutes and/or other suitable time period.

In embodiments, the multi function charger case can enable (e.g., when kept near to the user; etc.) charging of their in-ear utility devices fully for their day to day needs, and can be designed with a smaller form factor (e.g., with increased power, etc.), such as for users who require all-day power for their hearing aids, cell phone, and/or other suitable devices (e.g., users listening to music for extended periods; etc.).

Embodiments can provide an improved multi function charger case (e.g., miniature; etc.), to minimize user downtime and give more flexibility on being able to use wireless in-ear utility device(s) for their day to day activities with minimal downtime by having hot swappable battery modules.

In embodiments, the improved multi function charger case (e.g., miniature; etc.) can include the capability of recharging two in-ear utility devices and two battery modules allowing for the user to use their devices for longer periods of time and with minimal downtime, such as where hot swappable battery modules can facilitate quick swap out of battery modules for the in-ear utility devices.

In embodiments, the improved multi function charger case (e.g., miniature; etc.) can additionally or alternatively include separate chambers to charge two (and/or any suitable number) in-ear utility devices and two (and/or any suitable number) battery modules (e.g., where each can be charged simultaneously or individually; etc.).

In a specific example, the set of utility devices (e.g., that can be charged by the multi function charger case) can include at least one of an in-ear utility device and a mobile phone device. In a specific example, the set of utility devices comprises the in-ear utility device and a second in-ear utility device, wherein a first set of charging components (e.g., for charging a set of utility devices; etc.) is located proximal a first end of the multi function charger case, wherein a second set of charging components (e.g., for charging a set of battery modules; etc.) is located proximal a second end of the multi function charger case, and wherein the first end and the second end are opposite ends. In a specific example, the first set of charging compartments and the second set of charging compartments are operable to simultaneously charge the in-ear utility device, the second in-ear utility device, and the set of battery modules. In a specific example, the multi function charger case is operable to supply a total charging power of at least 40 hours, and wherein the total charging power is operable to provide at least 5 full charges each to the in-ear utility device, the second in-ear utility device, and the set of battery modules (e.g., two battery modules; etc.).

Embodiments of the wireless in-ear utility device may be used for a variety of purposes and include a variety of electronic packages, such as for use as a PSAP, hearing aids, music player, headphone device, and for use in various external health-monitoring applications accessories. Embodiments can provide a wireless in-ear utility device configured to have a variety of electronic packages. The electronic packages may serve a variety of functions, such as a Bluetooth device, noise cancellation device that allows the user to focus on sounds of interest, a health-awareness monitoring and safety awareness monitoring, fitness device, such as where embodiments or internal accessories devices can include the sensors and electronic configuration needed to carry out its mission in configuration with wireless in-ear utility device; such as where such applications can require large amounts of power, therefore presenting a need for one or more multi function charger cases (e.g., miniature; etc.) (e.g., that can allow for these devices to have minimum downtime and having the capability of swapping out the battery modules within 60 seconds or less and/or in any suitable time period; etc.). In an example, as shown in FIG. 5, the multi function charger case can charge battery modules 503, 504, and can be associated with an adapter cable that can plug into the multi function charger case (e.g., miniature; etc.) USB-C port, for facilitating charging of other devices (e.g., within 30 minutes; etc.)

One or multi function chargers, associated functionality, and/or associated components can be implemented in any suitable form factor (e.g., in addition to or alternative to a case). Form factors can include any one or more of: circles, squares, rectangles, ellipses, triangles, hexagons, polygons, quadrangles, shapes with concave regions, and shapes with parabolic regions, and/or any other suitable multi-dimensional shapes (e.g., with any suitable number of sides, dimensions, areas, etc.). Additionally or alternatively, form factors can tip can include any suitable type and number of shapes, including any one or more of: cylinders, cubes, cuboids, spheres, cones, pyramids, prisms, and/or any other suitable multi-dimensional shapes (e.g., with any suitable number of edges, vertices, faces, etc.) with any suitable areas and/or volumes.

Battery modules can include chargeable lithium ion batteries and/or any suitable types of batteries.

Communication by and/or between any components of the system can include wireless communication (e.g., WiFi, Bluetooth, radiofrequency, etc.) and/or wired communication.

The components of the system 100 can be physically and/or logically integrated in any manner. However, distribution of functionality across components of the system 100 can be configured in any suitable manner.

However one or more multi function charger cases, associated functionality, and/or associated components can be configured in any suitable manner.

FIG. 1 includes an illustration of a multi function charger case (e.g., miniature; etc.) 101 including a micro USB-C fast charging port 102, and three to five light-emitting diodes (LEDs) 103, 104, 105 to provide the user feedback (e.g., visual feedback; in relation to providing feedback regarding one or more chargeable device modules, such as one or more wireless in-ear utility device; etc.), where in a specific example, the LEDs can flash three colors red for 0% to 20% charged, blue for 20% to 50% charged, and green for 50% to 100% charged, and when it's 100% charged the LEDs turn-off, according to a variation of an embodiment. FIG. 1 additionally includes an illustration of battery modules 106, 107, which can additionally or alternatively facilitate provision of user feedback (e.g., visual feedback; etc.) such as in the form of LEDs, where such user feedback can be the same or different from feedback associated with LEDs 103, 104, 105, according to a variation of an embodiment.

A multi function charger case can include any suitable number of LEDs and/or light components for providing any type of visual feedback to a user (e.g., in associated with charging of one or more battery modules; etc.). In variations, any suitable type of light component types can be used (e.g., in addition to or alternative to LEDs and/or light components described herein; with any suitable functionality associated with LEDs and/or light components described herein etc.), such as including any one or more of: fluorescent, incandescent, solar, halogen, and/or any suitable types of light components.

One or more multi function charger cases can preferably provide one or more types of visual feedback (e.g., lights, text, graphics, video, images, etc.), but any suitable types of feedback can be additionally or alternatively provided (e.g., by any suitable feedback components; etc.), including any one or more of: audio feedback, haptic feedback, touch feedback, and/or any suitable types of feedback.

In variations, and suitable colors of visual feedback can be provided (e.g., and/or associated with any suitable indicators, such as percentage ranges and/or other suitable range types regarding charge state; etc.). Any suitable charge states (e.g., any suitable percentage ranges and/or individual percentages of charge states; etc.) can be indicated by any individual light colors and/or combination of lights colors (e.g., using any suitable combination and/or number of LEDs and/or light components; etc.). User feedback can be provided at any suitable time and frequency.

In a specific, the set of utility devices comprises a first in-ear utility device and a second in-ear utility device, wherein the set of battery modules comprises a first battery module and a second battery module, wherein the multi function charger case is operated by firmware for individually monitoring the first in-ear utility device, the second in-ear utility device, the first battery module, and the second battery module, and wherein the multi function charger case comprises: a first light component located proximal to a first charging compartment, of the first set of charging compartments, wherein the first charging compartment is operable to charge the first in-ear utility device; a second light component located proximal to a second charging compartment, of the first set of charging compartments, wherein the second charging compartment is operable to charge the second in-ear utility device; a third light component located proximal to a third charging compartment, of the second set of charging compartments, wherein the third charging compartment is operable to charge the first battery module; a fourth light component located proximal to a fourth charging compartment, of the second set of charging compartments, wherein the fourth charging compartment is operable to charge the second battery module, and wherein the first light component, the second light component, the third light component, and the fourth light component are operable to provide visual feedback regarding charging condition for the first in-ear utility device, the second in-ear utility device, the first battery module, and the second battery module, respectively.

In a specific example, first light component and the second light component are triggered to provide first feedback of the visual feedback in response to closure of a first lid for the first charging compartment and the second charging compartment, wherein the third light component and the fourth light component are triggered to provide second feedback of the visual feedback in response to closure of a second lid for the third charging compartment and the fourth charging compartment, and wherein, in response to the closure of the first lid, in-ear utility device battery modules are disconnected (e.g., by triggering of a magnetic switch and/or other suitable trigger; etc.;.) from the first in-ear utility device and the second in-ear utility device for facilitating charging of the first in-ear utility device and the second in-ear utility device via the in-ear utility device battery modules.

In a specific example, the multi function charger case can include an internal battery monitored individually by the firmware; and a fifth light component located below and proximal a center of the multi function charger case, wherein the fifth light component is operable to provide internal battery-associated visual feedback regarding internal battery charging condition.

The multi function charger case can itself be charged through a USB-C fast charging port 102, and/or any suitable type of charging port (e.g., for any suitable connector system; etc.).

However, LEDs, light components, charging ports, user feedback, and/or suitable components can be configured in any suitable manner.

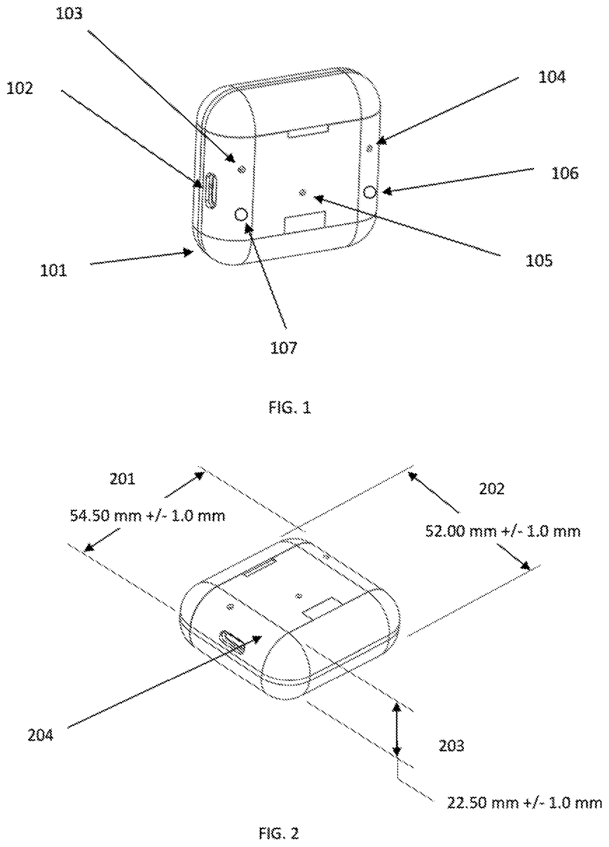

FIG. 2 includes an illustration of multi function charger case (e.g., miniature; etc.) with an outer circumference designed to accommodate a shape that can be conveniently put in a pocket and/or purse so that the user can carry the miniaturize multi charger around (e.g., all day and/or for any suitable period of time; etc.), such as based on the dimensions indicated by 201, 202 and/or 203 for the form factor. In a specific example, as shown in FIG. 2, where if the battery modules are not included, removed, or not needed as part of the multi function charger case (e.g., miniature; etc.) configuration, the additional LEDs (e.g., 106, 107 as shown in FIG. 1) are not visible at the location shown by 204 (e.g., where LEDs 106 and/or 107 can be located at such locations as shown in FIG. 1 when one or more battery modules are included; etc.), according to a variation of an embodiment. In a specific example, the multi function charger case can be characterized by a form factor (e.g., small form factor) comprising a first dimension (e.g., 201) at or below 55.50 mm, a second dimension (e.g., 202) at or below 53.00 mm, and a third dimension (e.g., 203) at or below 23.50 mm. In a specific example, the multi function charger case can be characterized a form factor adapted to portability (e.g., while still allowing a user to swap out battery modules in 60 seconds or less and/or other suitable time periods; etc.), such as to minimum downtime from using in-ear utility devices.

However, a multi function charger case, individual components and/or combinations of components of the multi function charger case can be characterized by any lengths, widths, heights, depths, radiuses, circumferences, and/or any suitable dimensions, amounting to any suitable dimensions, and which can correspond to any suitable areas, volumes, and/or other suitable multi-dimensional characteristics.

Any number of battery modules (e.g., charged; chargeable; to be charged; etc.) can be included or not included in one or more multi function charger cases. One or more battery modules can have any suitable feedback provision functionality (e.g., for providing any suitable types of user feedback, such as types of user feedback described herein, etc.). In specific examples, one or more battery modules can (e.g., in addition to and/or alternative to charging capabilities, etc.) include and/or be associated with one or more LEDs (e.g., in addition to or alternative to separate LEDs, such as 103, 104, 105, etc.) of the multi function charger case. In specific examples, one or more battery modules can include and/or be associated with any suitable user feedback provision components.

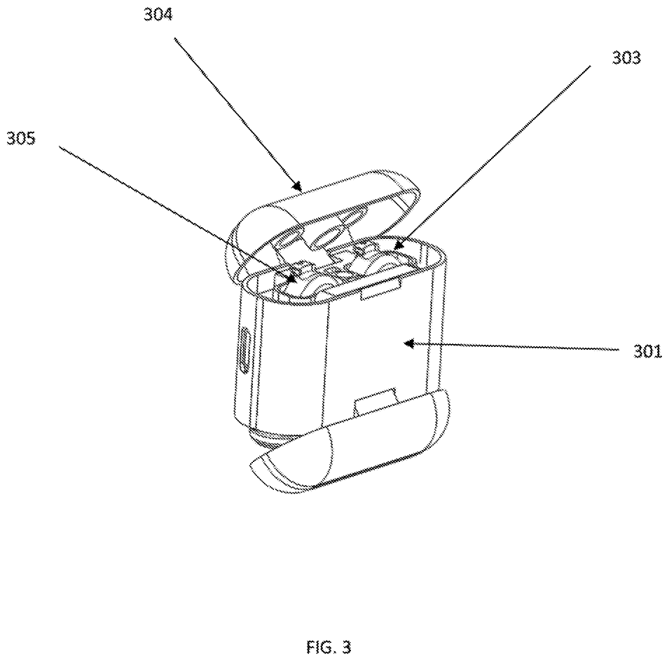

FIG. 3 includes an illustration of a multi function charger case (e.g., miniature; etc.) 301; two battery modules 303, 305 inserted into the multi function charger case (e.g., miniature; etc.) 301; a lid 304 (e.g., physically attached to the multi function charger case 301, etc.) include a magnetic latch (e.g., and/or other suitable latch type) to hold the battery modules from falling out of the charger case, such as where the multi function charger case (e.g., miniature; etc.) 301 can charge two battery modules simultaneously or one at a time (e.g., in serial, individually etc.), according to a variation of an embodiment.

A multi function charger case (e.g., miniature) can include any suitable number of compartments (e.g., cavities) for holding (e.g., housing) any suitable number of battery modules (e.g., operable to be used by any number of in-ear utility device modules and/or other suitable devices; operable to be charged by the multi function charger case simultaneously or individually; etc.). The multi function charger case preferably includes a lid 304, which preferably includes a magnetic latch for closing the lid 304 and inhibiting the one or more battery modules from escaping the multi function charger case (e.g., and/or to enable functional charging by the charger case; etc.). Additionally or alternatively, any suitable latches and/or closure mechanisms can be used (e.g., mechanical, adhesive, etc.) for closure of the lid 304. Charging of the one or more battery modules can be performed simultaneously (e.g., for devices to be charged; simultaneously with charging of one or more wireless in-ear utility device modules and/or other suitable devices; etc.), individually (e.g., for devices to be charged; etc.), and/or at any suitable time and frequency. However, battery modules, associated compartments (e.g., cavities), and/or associated lids can be configured in any suitable manner.

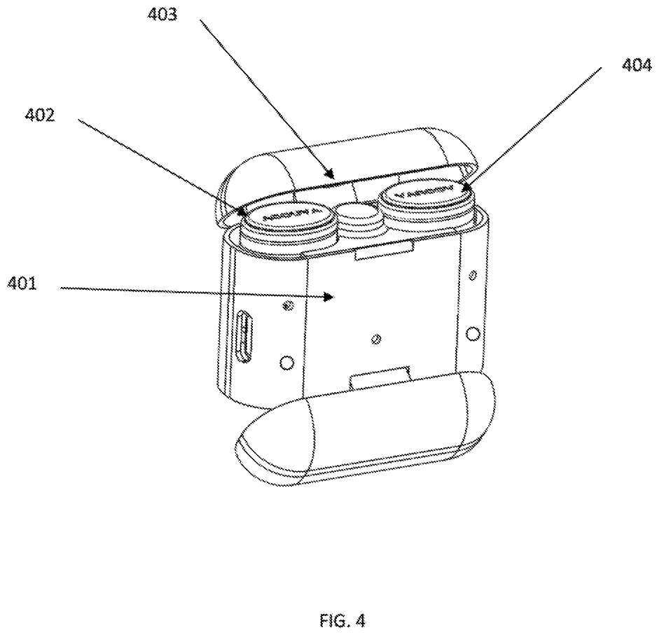

FIG. 4 includes an illustration of a multi function charger case (e.g., miniature; etc.) 401; two wireless in-ear utility device modules 402, 404 (and/or other suitable devices) inserted into multi function charger case (e.g., miniature; etc.) 401; a lid 403 including a magnetic latch (e.g., and/or other suitable latch type) to hold the wireless in-ear utility device modules 402, 404 from falling out of the multi function charger case (e.g., miniature; etc.) 401, such as where the magnet is located for and used to turn off and/or disconnect one or more wireless in-ear utility device modules 402, 404 while charging in the multi function charger case (e.g., miniature; etc.) 401, according to a variation of an embodiment.

A multi function charger case (e.g., miniature) can include any suitable number of compartments (e.g., cavities) for holding (e.g., housing) any suitable number of wireless in-ear utility device modules (e.g., hearing aids; any suitable devices, etc.) operable to be charged the charger case (e.g., where the wireless in-ear utility device modules include one or more battery modules that can be charged by the charger case; etc.). The multi function charger case preferably includes a lid 403, which preferably includes a magnetic latch for closing the lid 403 and inhibiting the one or more wireless in-ear utility device modules from escaping the multi function charger case (e.g., and/or to enable functional charging by the charger case; etc.). However, any suitable latches and/or closure mechanisms can be used (e.g., mechanical, adhesive, etc.) for closure of the lid 304. Charging of wireless in-ear utility device modules (e.g., inserted into the multi function charger case; etc.) and/or other suitable chargeable devices can be performed simultaneously (e.g., for devices to be charged; simultaneously with individual battery modules, such as those inserted into compartments proximal the opposite end of the multi function charger case; etc.), individually (e.g., for devices to be charged; etc.), and/or at any suitable time and frequency. However compartments (e.g., cavities) for wireless in-ear utility device modules and/or other suitable devices, and/or associated lids, can be configured in any suitable manner.

FIG. 5 includes an illustration of a multi function charger case (e.g., miniature; etc.) 501; two battery modules 503, 504 entering the compartments (e.g., cavities; etc.) 502, 505, respectively, of the multi function charger case (e.g., miniature; etc.) 501; and one or more utility device battery modules 506 of one or more wireless in-ear utility devices and/or other suitable utility devices, such as where the utility device battery module 506 can snap out of one or more wireless in-ear utility devices (e.g., to be operated based on the one or more battery modules; etc.); such as where the one or more utility device battery modules 506 can be chargeable by the charger cases simultaneously or individually along with the battery modules 503, 504 when the one or more utility device battery modules 506 and the battery modules 503, 504 are inserted in the multi function charger case 501; such as where the utility device battery module can be replaced by a fully (or partially) charged battery module 503 or fully (or partially) charged battery module 504, according to a variation of an embodiment.

Any suitable number of utility device battery modules (e.g., as part of a wireless in-ear utility device module housing the utility device battery module; etc.) and/or individual battery modules can be inserted in, housed by, connected to, charged by (e.g., simultaneously, individually, etc.), and/or associated with one or more multi function charger cases. However, any suitable configuration of utility device battery modules and/or individually battery modules can be implemented.

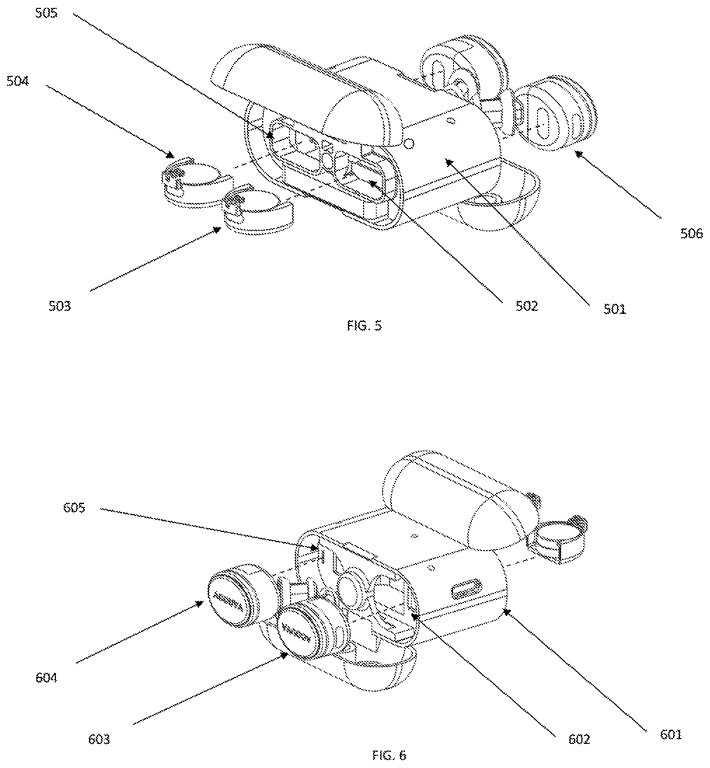

FIG. 6 includes an illustration of an embodiment of a multi function charger case (e.g., miniature; etc.) 601; two wireless in-ear utility device modules 603, 604 (e.g., connected to utility device battery modules; etc.) entering the compartments (e.g., cavities; etc.) 602, 605 of the multi function charger case (e.g., miniature; etc.) 601, according to a variation of an embodiment.

The wireless in-ear utility device modules 603/604 can be removed (e.g., from ear canals of a user; etc.) and placed in the multi function charger case (e.g., miniature; etc.) 601, by hand and/or by any suitable means. Any suitable number of in-ear utility device modules can be charged by the charger case (e.g., when placed in any suitable corresponding compartments of the multi function charger case; etc.) Wireless in-ear utility device modules described herein can include the entire wireless in-ear utility devices, and/or any suitable portions of the wireless in-ear utility devices. Additionally or alternatively, any suitable hearing-associated utility devices can be charged by the charger case. However, any suitable chargeable utility device modules can be inserted into the charger case in any suitable manner.

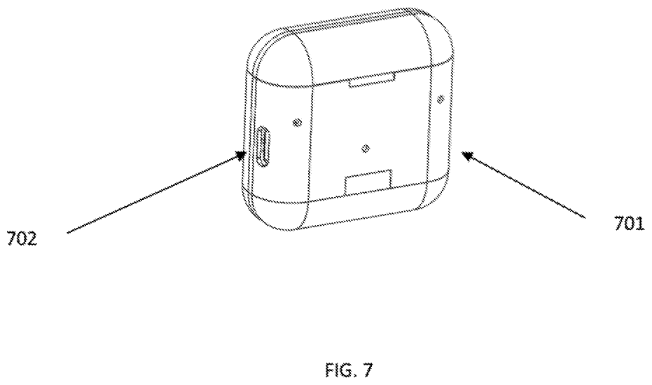

FIG. 7 includes an illustration of a multi function charger case (e.g., miniature; etc.) 701 and a USB-C port 702 for fast charging, which can allow a user to have two (and/or any suitable number) wireless in-ear utility device modules (e.g., including two utility device battery modules) and two (and/or any suitable number) battery modules (e.g., individual battery modules, etc.) to be charged (e.g., fully charged in 30 minutes or less; in any suitable time period; etc.), such as where the internal battery of the charger case can have any suitable battery life (e.g., up to 40 hours of battery life, etc.) and can allow for the user to charge wireless in-ear utility device modules and/or individual battery modules any suitable number of times (e.g., 5 times, etc.) before having to recharge the multi function charger case (e.g., miniature; etc.), according to a variation of an embodiment.

Any number of tasks may be performed using the multi function charger case (e.g., miniature; etc.). One or more multi function charger cases can include any type and number of in-ear devices, such as hearing aids and/or wearable devices. Any suitable electronics can reside (e.g., be housed, etc.) in the multi function charger case (e.g., miniature; etc.). Wireless in-ear utility devices and/or suitable utility devices (e.g., for charging by a multi function charger case; etc.) described herein can include, be analogous to, and/or be associated with any suitable portion of one or more in-ear utility devices described in U.S. patent application Ser. No. 15/950,110 filed 10 Apr. 2018 and titled “IN-EAR WIRELESS DEVICE WITH BONE CONDUCTION MIC communication” (Attorney Docket No. Aco-P01-US), and/or U.S. patent application Ser. No. ______ filed ______ and titled “MINIATURE FORM FACTOR BLUETOOTH DEVICE” (Attorney Docket No. Aco-P05-US), which are each incorporated in their entirety by this reference.

In a specific example, a location of the multi function charger case is operable to be wirelessly tracked (e.g., via WiFi, Bluetooth, etc.) via at least one of a wireless module of the multi function charger case and a wireless module of the set of utility devices, wherein the multi function charger case comprises a speaker operable to emit audio (e.g., beeping, etc.) in response to a user distance exceeding a threshold distance relative to the multi function charger case (e.g., where a user can be directed to the location of the multi function charger case through GPS location aspects, and/or where a user can track the movement of the multi function charger case, etc.).

In a specific example, the multi function charger case can include a wireless module operable to provide a hotspot for a wireless network (e.g., WiFi network with smartphones, desktop computers, tablets, laptop computers, and/or any devices that require a wireless network; etc.). In a specific example, the multi function charger case can include a storage component (e.g., memory; 1-terbyte memory housed in the multi function charger case; etc.) operable to receive uploaded data from an uploading device (e.g., smartphones, desktop computers, tablets, laptop computers, and/or any devices; etc.), wherein the uploaded data can be retrieved by a user. from smartphone/pc/tablets that the user can backup and retrieve it later from the internal 1-terabyte memory that's within the multi function charger case (e.g., miniature; etc.). In a specific example, the uploaded data comprises audio-associated media (e.g., music, audio books, podcasts, etc.), wherein the multi function charger case comprises a wireless module connectable (e.g., via WiFi, Bluetooth, etc.) to by a set of users for accessing the audio-associated media (e.g., for playback; where a group of 5 or more users can access the audio-associated media, such as via in-ear utility devices, without the need of having any other devices to listen to as a group or individual; etc.).

The multi function charger case can additionally or alternatively function as an assistant listening device. For example, the multi function charger can function as a security monitoring system with a multi functioning communication for a smart home utility and for safety, such as for allowing users to have one device to communicate with (e.g., for facilitating and improving daily life; etc.). In a specific example, if there is a fire in a room that is in a far room that the user cannot hear a smoke detector alarm, the multi function charger case can detect it and sound off an alarm to wake up the user and tell them where the fire is located and to proceed with extreme caution, and/or can call an emergency unit and/or contact any specified individual.

In a specific example, when the set of utility devices resides in the first set of charging compartments, the multi function charger case operates as an assistant listening device for executing at least one action activated by at least one voice command received via at least one of a microphone of the multi function charger case and a microphone of the set of utility devices. In a specific example, any suitable voice commands can be used for activating one or more actions, such as a voice command of “Acouva” to initialize the beginning of a voice command. In specific examples, one or more actions can include making or answering phone calls, text messages, music, memos, calendar setup, conference calls, and/or other suitable actions.

In a specific example, the at least one action comprises emitting pre-selectable alarm clock audio from an external speaker of the multi function charger case. In a specific example, the at least one action comprises emitting security system-associated audio from an external speaker of the multi function charger case, wherein the security system-associated audio is emitted in response to receiving communication indicating detection of a presence of an entity by a security system (e.g., detection of motion of an individual at a front door; etc.). In a specific example, the multi function charger case, in conjunction with a mobile device, is wirelessly connectable to an external device comprising a smoke detector, wherein the at least one action comprises an audible noise of at least 20 decibels predetermined by firmware of the multi function charger case, wherein the firmware is programmable to call local emergency units in response to detection of an emergency. In a specific example, the at least one action can include wirelessly controlling at least one of a light component (e.g., an external light component; a light component of the multi function charger case; etc.), a car (e.g., starting a car; controlling one or more operations of the car; etc.), and a door (e.g., locking or unlocking a door; opening or closing a door; etc.). In a specific example, the at least one action comprises facilitating a conference phone call for a set of users using an internal microphone and an external speaker of the multi function charger case. In a specific example, the speaker can broadcast audio relating to the conference call, and the internal microphone can receive audio inputs for the conference call. In a specific example, the at least one action comprises, in conjunction with a wirelessly connectable health awareness sensor, detecting an emergency situation and initiating communication with an emergency contact. In a specific example, the multi function charger case and/or one or more utility devices can wirelessly connect (e.g., WiFi, Bluetooth, etc.) with a health awareness sensor (e.g., which can be triggered and/or monitored by the multi function charger case, etc.), such as for facilitating detection if the user is asking for help or has fallen, and in response, calling emergency units and contact one or more emergency contacts (e.g., via cell phone call or text message depending on how the user has configured their setup; etc.).

Embodiments can include every combination and permutation of the various system components and the various processes, including any variants (e.g., embodiments, variations, examples, specific examples, figures, etc.), where portions of embodiments described herein can be performed asynchronously (e.g., sequentially), concurrently (e.g., in parallel), or in any other suitable order by and/or using one or more instances, elements, components of, and/or other aspects of the system (e.g., multi function charger case; etc.) and/or other entities described herein.

Any of the variants described herein (e.g., embodiments, variations, examples, specific examples, figures, etc.) and/or any portion of the variants described herein can be additionally or alternatively combined, aggregated, excluded, used, performed serially, performed in parallel, and/or otherwise applied.

Portions of embodiments can be embodied and/or implemented at least in part as a machine configured to receive a computer-readable medium storing computer-readable instructions. The instructions can be executed by computer-executable components that can be integrated with embodiments of the system 200. The computer-readable medium can be stored on any suitable computer-readable media such as RAMs, ROMs, flash memory, EEPROMs, optical devices (CD or DVD), hard drives, floppy drives, or any suitable device. The computer-executable component can be a general or application specific processor, but any suitable dedicated hardware or hardware/firmware combination device can alternatively or additionally execute the instructions.

As a person skilled in the art will recognize from the previous detailed description and from the figures and claims, modifications and changes can be made to embodiments and/or variants without departing from the scope defined in the claims. Variants described herein not meant to be restrictive. Certain features included in the drawings may be exaggerated in size, and other features may be omitted for clarity and should not be restrictive. The figures are not necessarily to scale. Section titles herein are used for organizational convenience and are not meant to be restrictive. The description of any variant is not necessarily limited to any section of this specification.

Various embodiments been described in detail with reference to the accompanying drawings. References made to particular examples and implementations are for illustrative purposes, and are not intended to limit the scope.

It should be apparent to those skilled in the art that modifications of components described herein (e.g., charger cases, battery modules, utility devices, etc.) are possible without departing from the concepts herein.

Headings and sub-headings provided herein have been provided as assistance to the reader and are not meant to limit the scope disclosed herein. Headings and sub-headings are not intended to be the sole or exclusive location for the discussion of a particular topic.

While specific embodiments and variants have been illustrated and described, it will be clear that the variants are illustrative and can be modified without departing from the scope defined in the claims. Embodiments discussed herein may have generally implied the use of materials from certain named equipment manufacturers; however, the embodiments may be adapted for use with equipment from other sources and/or manufacturers. Equipment used in conjunction with the embodiments may be configured to operate according to conventional protocols (e.g., wi-fi and Bluetooth that require extreme amount of power with minimum downtime) and/or may be configured to operate according to specialized protocols and/or any suitable protocols. Numerous modifications, changes, variations, substitutions and equivalents will be apparent to those skilled in the art without departing from the spirit and scope described in the claims. In general, in the claims, the terms used should not be construed to be limited to the specific embodiments disclosed in the specification. Thus, it is intended that the claims covers modifications of variants described herein provided they come within the scope of the appended claims and their equivalents.

All publications herein are incorporated by reference to the same extent as if each individual publication or patent application was specifically and individual indicated to be incorporated by reference. Where a definition or use of a term in an incorporated reference is inconsistent or contrary to the definition of that term provided herein, the definition or use of that term provided herein applies and the definition of that term in the reference does not apply.

We claim:

1. A multi function charger case, comprising:
a first set of charging compartments for charging a set of utility devices insertable into the first set of charging compartments of the multi function charger case; and
a second set of charging compartments for charging a set of battery modules insertable into the second set of charging components of the multi function charger case, wherein the set of battery modules is operable to power the set of utility devices upon charging of the set of battery modules by the multi function charger case.

2. The multi function charger case of claim 1, wherein the multi function charge case is characterized by a form factor comprising a first dimension at or below 55.50 mm, a second dimension at or below 53.00 mm, and a third dimension at or below 23.50 mm.

3. The multi function charger case of claim 1, wherein the set of utility devices comprises at least one of an in-ear utility device and a mobile phone device.

4. The multi function charger case of claim 3, wherein the set of utility devices comprises the in-ear utility device and a second in-ear utility device, wherein the first set of charging components is located proximal a first end of the multi function charger case, wherein the second set of charging components is located proximal a second end of the multi function charger case, and wherein the first end and the second end are opposite ends.

5. The multi function charger case of claim 4, wherein the first set of charging compartments and the second set of charging compartments are operable to simultaneously charge the in-ear utility device, the second in-ear utility device, and the set of battery modules.

6. The multi function charger case of claim 5, wherein the multi function charger case is operable to supply a total charging power of at least 40 hours, and wherein the total charging power is operable to provide at least 5 full charges each to the in-ear utility device, the second in-ear utility device, and the set of battery modules.

7. The multi function charger case of claim 1, wherein the set of utility devices comprises a first in-ear utility device and a second in-ear utility device, wherein the set of battery modules comprises a first battery module and a second battery module, wherein the multi function charger case is operated by firmware for individually monitoring the first in-ear utility device, the second in-ear utility device, the first battery module, and the second battery module, and wherein the multi function charger case comprises:
a first light component located proximal to a first charging compartment, of the first set of charging compartments, wherein the first charging compartment is operable to charge the first in-ear utility device;
a second light component located proximal to a second charging compartment, of the first set of charging compartments, wherein the second charging compartment is operable to charge the second in-ear utility device;
a third light component located proximal to a third charging compartment, of the second set of charging compartments, wherein the third charging compartment is operable to charge the first battery module;
a fourth light component located proximal to a fourth charging compartment, of the second set of charging compartments, wherein the fourth charging compartment is operable to charge the second battery module, and wherein the first light component, the second light component, the third light component, and the fourth light component are operable to provide visual feedback regarding charging condition for the first in-ear utility device, the second in-ear utility device, the first battery module, and the second battery module, respectively.

8. The multi function charger case of claim 7, wherein the first light component and the second light component are triggered to provide first feedback of the visual feedback in response to closure of a first lid for the first charging compartment and the second charging compartment, wherein the third light component and the fourth light component are triggered to provide second feedback of the visual feedback in response to closure of a second lid for the third charging compartment and the fourth charging compartment, and wherein, in response to the closure of the first lid, in-ear utility device battery modules are disconnected from the first in-ear utility device and the second in-ear utility device for facilitating charging of the first in-ear utility device and the second in-ear utility device via the in-ear utility device battery modules.

9. The multi function charger case of claim 7, further comprising:
an internal battery monitored individually by the firmware; and
a fifth light component located below and proximal a center of the multi function charger case, wherein the fifth light component is operable to provide internal battery-associated visual feedback regarding internal battery charging condition.

10. The multi function charger case of claim 1, wherein a location of the multi function charger case is operable to be wirelessly tracked via at least one of a wireless module of the multi function charger case and a wireless module of the set of utility devices, wherein the multi function charger case comprises a speaker operable to emit audio in response to a user distance exceeding a threshold distance relative to the multi function charger case.

11. The multi function charger case of claim 1, further comprising a wireless module operable to provide a hotspot for a wireless network.

12. The multi function charger case of claim 1, further comprising a storage component operable to receive uploaded data from an uploading device, wherein the uploaded data can be retrieved by a user.

13. The multi function charger case of claim 12, wherein the uploaded data comprises audio-associated media, wherein the multi function charger case comprises a wireless module connectable to by a set of users for accessing the audio-associated media.

14. The multi function charger case of claim 1, wherein, when the set of utility devices resides in the first set of charging compartments, the multi function charger case operates as an assistant listening device for executing at least one action activated by at least one voice command received via at least one of a microphone of the multi function charger case and a microphone of the set of utility devices.

15. The multi function charger case of claim 14, wherein the at least one action comprises emitting pre-selectable alarm clock audio from an external speaker of the multi function charger case.

16. The multi function charger case of claim 14, wherein the at least one action comprises emitting security system-associated audio from an external speaker of the multi function charger case, wherein the security system-associated audio is emitted in response to receiving communication indicating detection of a presence of an entity by a security system.

17. The multi function charger case of claim 14, wherein the multi function charger case, in conjunction with a mobile device, is wirelessly connectable to an external device comprising a smoke detector, wherein the at least one action comprises an audible noise of at least 20 decibels predetermined by firmware of the multi function charger case, wherein the firmware is programmable to call local emergency units in response to detection of an emergency.

18. The multi function charger case of claim 14, wherein the at least one action comprises wirelessly controlling at least one of a light component, a car, and a door.

19. The multi function charger case of claim 14, wherein the at least one action comprises facilitating a conference phone call for a set of users using an internal microphone and an external speaker of the multi function charger case.

20. The multi function charger case of claim 14, wherein the at least one action comprises, in conjunction with a wirelessly connectable health awareness sensor, detecting an emergency situation and initiating communication with an emergency contact.
